(19) United States
(12) Patent Application Publication
(10) Pub. No.: US 2025/0013215 A1
(43) Pub. Date: Jan. 9, 2025

(54) METHOD AND SYSTEM FOR OPERATING AN ENERGY MANAGEMENT SYSTEM

(71) Applicant: Hitachi Energy Ltd, Zürich (CH)

(72) Inventors: Pablo ALMALECK, Genova (IT); Donato ZARRILLI, Hamburg (DE); Alessio LA BELLA, Milano (IT); Lorenzo Mario FAGIANO, Bergamo (IT); Fredy Orlando RUIZ PALACIOS, Milano (IT); Riccardo SCATTOLINI, Milano (IT)

(21) Appl. No.: 18/710,947

(22) PCT Filed: Nov. 17, 2021
(86) PCT No.: PCT/IT2021/000053

§ 371 Date: May 16, 2024

(51) Int. Cl. G05B 19/042

(52) U.S. Cl. CPC G05B 19/042; G05B 2219/2639

(57) ABSTRACT

Methods and systems for operating an energy management system (EMS) for a microgrid are operative to automatically determine weights by which different objective functions are weighted in a multi-objective optimization performed by the EMS.

### FIELD OF THE INVENTION

Embodiments of the invention relate to methods, devices and systems for operating an energy management system for a microgrid. Embodiments of the invention relate in particular to methods, devices and systems that allow operation of an energy management system to be adjusted.

### BACKGROUND OF THE INVENTION

A microgrid is a localized group comprising energy-generating assets (such as renewable energy resources and/or generators), loads, and optional energy storage systems. Control strategies for microgrids are getting increasingly important, also due to the increasing use of renewable energy sources (RES), energy storage systems (ESS), such as a battery ESS (BESS), or other systems with distributed energy generators (DEG). Control techniques for microgrids are described in, e.g., IEEE 2030.7-2017.

A microgrid control system may be a Power Management System (PMS) that can coordinate a plurality of individual controllable power-generating assets and discretionary load (DL) assets in a predefined way. The Operating Point (OP) of each asset may be calculated in real-time based on locally known values, such as total load, microgrid configuration, storage state of charge (SoC), current photovoltaic (PV) and wind availability, other penalizing factors etc. In such a case, the optimization that is attained may be limited because the PMS only knows local values and has only past and present-time data.

In order to further improve the determination of an operating point, an Energy Management System (EMS) may use forecasts to calculate a better optimal OP for each of the assets. Forecasts can be or can include forecast values for load profiles, photovoltaic and wind availability, weather and cloud forecasting, other penalizing factors etc. With the use of past, present and forecasted data, the EMS is adapted to calculate the optimal OP for each asset. This may be done over a predictive time horizon.

The EMS may perform a multi-objective optimization (MOO) to determine asset operating points over a predictive time horizon. Weights by which various objective functions are weighted in the MOO can be set based on expert knowledge. This human involvement may be prone to causing errors. For illustration, weights for a MOO may be selected by a human expert that are not suitable for at least some scenarios.

### SUMMARY

In view of the above, there is a continued need for enhanced methods, devices, systems, and microgrids that allow asset operating points to be determined in a reliable manner. There is also a need for methods, devices, systems, and microgrids that allow operation of an energy management system (EMS) to be tuned. There is also a need for methods, devices, systems, and microgrids that allow operation of an EMS to be tuned in accordance with the use case in which the EMS is intended to be used. There is also a need for methods, devices, systems, and microgrids that allow operation of an EMS to be tuned based on objective criteria and without requiring human expert input.

According to the invention, a method and system as recited in the independent claims are provided. The dependent claims define preferred embodiments.

Embodiments of the invention provide a method and system to automatically tune an energy management systems (EMS) for electric microgrids. The EMS may employ an energy management approach based on numerical optimization, able to plan the resource allocation of the microgrid in order to minimize a composite objective function. The available resources may include the possibility to buy/sell energy to/from a main grid to which the microgrid is connected, local dispatchable generators using e.g. fossil fuels, renewable energy systems like wind and solar PV, controllable loads, energy storage systems such as batteries. The chosen objective function considers several performance indicators, such as penalties imposed by energy exchanged with the main grid, penalties imposed by shifting loads with respect to a nominal consumption profile, and cumulative wear of the storage system.

According to embodiments, weighty by which different objective functions are multiplied in the composite objective function are determined automatically and are used by the EMS.

According to an aspect of the invention, there is provided a method of operating an EMS for a microgrid. The EMS performs a multi-objective optimization (MOO) to determine one or several asset operating points over a predictive time horizon. Performing the MOO determines the one or several asset operating points as a function of time over the predictive time horizon that minimize a composite objective function that is a weighted sum of several objective functions.

The method may comprise using the MOO in field use of the EMS.

The method may comprise using the MOO to perform a corrective or preventive operation in an electric power system.

The method may comprise using the MOO to perform at least one protective action.

The method may comprise using the MOO to control an output interface.

The method may comprise using the MOO to control an output interface to output an alarm, warning, status information, or other electric power system related information.

The method comprises automatically determining, by at least one integrated circuit, weights by which the several objective functions are weighted in the composite objective function that is to be used by the EMS in the MOO.

Automatically determining the weights by which the objective functions are to be weighted in the composite objective function that is to be used by the EMS in the MOO may comprise the following steps performed using the at least one integrated circuit: determining a set of utopia values, each of the utopia values corresponding to an optimal value of one of the several objective functions when optimized independently of the other objective functions; determining a Pareto front of optimal solutions, each of the optimal solutions optimizing a different weighted sum of the several objective functions; and determining the weights by which the objective functions are to be weighted based on the Pareto front and the set of utopia values.

The term “utopia value” refers to a value of one of the several objective functions as optimized, when the optimization is performed independently of the other objective functions included in the composite objective function. Thus, the “utopia value” is the optimal value for just one of the objective functions when optimized disregarding the other objective functions included in the composite objective function. When the MOO is performed, the contribution of an objective function to the optimal value of the composite objective function is greater than the utopia value for this objective function, because the MOO considers several competing objectives.

Determining the weights based on the Pareto front and the set of utopia values may comprise determining a utopia point having coordinates defined by the set of utopia values.

Determining the weights based on the Pareto front and the set of utopia values may comprise determining distances of the utopia point from points on the Pareto front.

Determining the weights based on the Pareto front and the set of utopia values may comprise determining a point on the Pareto front that has a minimum distance from the utopia point.

The weights by which the objective functions are weighted in the composite objective function may be determined based on weights applied to the several objective functions when determining the point on the Pareto front that has the minimum distance from the utopia point.

Determining the utopia values may comprise determining a first utopia value that represents a minimum of a first objective function associated with energy production at a grid to which the microgrid is connected and determining a second utopia value associated with local energy production at the microgrid.

The second utopia value associated with local energy production may include emission effects. Determining the weights may comprise determining a first weight by which a first objective function associated with energy production at a grid to which the microgrid is connected is multiplied in the composite objective function, a second weight by which a second objective function associated with local energy production at the microgrid is multiplied in the composite objective function.

Determining the weights may comprise determining a third weight by which a third objective function associated with an energy storage system, in particular a battery energy storage system, BESS, of the microgrid is multiplied.

The second objective function may include emission effects.

Determining the utopia values and determining the Pareto front may respectively comprise performing an optimization under constraints.

The constraints may comprise one or more of power balance, consistency of a load profile and/or power generation of the microgrid with a predetermined scenario.

The constraints may comprise technical constraints of microgrid assets.

The constraints may comprise microgrid operator preferences.

The steps of determining the utopia values, determining the Pareto front, and determining the weights may respectively be performed for each one of a plurality of different scenarios.

The different scenarios may be distinguished from each other with respect to load and/or power generation profiles of the microgrid.

The method may comprise clustering data obtained for a plurality of microgrids to identify a plurality of use cases.

The weights used by the EMS may be selected based on the microgrid specification as compared to the use cases.

Automatically determining the weights may be performed for at least one of the use cases which may be selected based on the microgrid specification.

The method may further comprise performing, by the EMS, the MOO to determine the one or several asset operating points as a function of time over the predictive time horizon, wherein the objective function in the MOO depends on the determined weights.

The predictive time horizon may comprise at least 6 hours, at least 12 hours, at least 18 hours, at least 24 hours, or at least 48 hours.

The method may further comprise controlling at least one asset of the microgrid in dependence on the determined asset operating points.

The method may further comprise providing, by the EMS, the operating points to a power management system (PMS).

The method may comprise controlling, by the PMS, controllable assets of the microgrid in accordance with the operating points determined by the EMS.

According to another aspect, a system for controlling operation of an EMS is provided. The EMS is operative to perform a MOO to determine one or several asset operating points over a predictive time horizon, wherein the MOO determines the one or several asset operating points as a function of time over the predictive time horizon that minimize a composite objective function that is a weighted sum of several objective functions. The system comprises at least one integrated circuit operative to automatically determine weights by which the objective functions are weighted in the composite objective function that is to be used by the EMS in the MOO, and an interface to provide the determined weights to the EMS.

The system may be operative to perform the method according to an embodiment.

The system may be operative to use the MOO to perform a corrective or preventive operation in an electric power system.

The system may be operative to use the MOO to perform at least one protective action.

The system may be operative to use the MOO to control an output interface.

The system may be operative to use the MOO to control an output interface to output an alarm, warning, status information, or other electric power system related information.

A microgrid according to an embodiment comprises plurality of controllable assets, an EMS operative to perform a MOO to determine one or several asset operating points over a predictive time horizon, wherein the MOO determines the one or several asset operating points as a function of time over the predictive time horizon that minimize a composite objective function that is a weighted sum of several objective functions, and the system for controlling operation of the EMS.

The microgrid may optionally comprise one or several loads.

The plurality of controllable assets may comprise controllable power-generating assets and/or controllable loads, such as controllable discretionary loads.

The plurality of controllable assets may comprise renewable energy sources.

The plurality of controllable assets may comprise discretionary loads.

The plurality of controllable assets may optionally comprise one or several generators and/or one or several energy storage systems (ESS).

The ESS may comprise a battery ESS (BESS).

The plurality of controllable assets may form a distributed energy generation system (DEG).

The microgrid may comprise additional assets that are not controllable by the EMS.

The additional assets may have operating parameters that may be sensed and that influence at least one of the objective functions in the MOO.

The microgrid may comprise a PMS.

The EMS and/or a separate device communicatively coupled to the EMS may be operative to perform the method according to the various embodiments disclosed herein.

The microgrid may be operative to use the MOO to perform a corrective or preventive operation in an electric power system.

The microgrid may be operative to use the MOO to perform at least one protective action.

The microgrid may be operative to use the MOO to control an output interface.

The microgrid may be operative to use the MOO to control an output interface to output an alarm, warning, status information, or other electric power system related information.

Various effects are attained using the methods and control systems according to embodiments. The methods and control systems according to embodiments address the need for enhanced reliability and reproducibility in determining operation parameters of a microgrid. The methods and control systems according to embodiments allow operation of an EMS to be tuned in dependence on the use case (e.g., specifics of the microgrid) for which the EMS is used.

### BRIEF DESCRIPTION OF THE DRAWINGS

The subject matter of the invention will be explained in more detail with reference to preferred exemplary embodiments which are illustrated in the attached drawings, in which:

FIG. 1 is a schematic representation of a microgrid.

FIG. 2 is a schematic representation of a microgrid.

FIG. 3 is a schematic representation of a microgrid.

FIG. 4 illustrates operation of a system of a microgrid.

FIG. 5 is a flow chart of a method.

FIG. 6 shows a Pareto front and a utopia point.

FIG. 7 is a flow chart of a method.

### DETAILED DESCRIPTION OF EMBODIMENTS

Exemplary embodiments of the invention will be described with reference to the drawings in which identical or similar reference signs designate identical or similar elements. While some embodiments will be described in the context of exemplary charging infrastructure concepts and/or exemplary on-board battery concepts, the embodiments are not limited thereto. The features of embodiments may be combined with each other, unless specifically noted otherwise.

Embodiments of the invention may be used to provide enhanced robustness and adaptability in the control of a microgrid. Operation of an energy management system (EMS) may be tuned by adjusting weights used in a multi-objective optimization (MOO). The adjustment may be performed automatically using at least one integrated circuit. The weights may be determined, depending on the use case in which the EMS is deployed. The weights may be determined based on

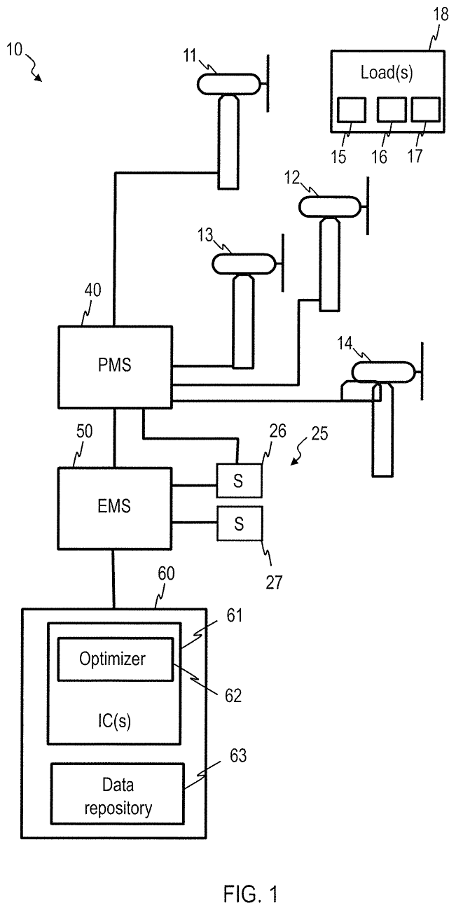

FIG. 1 shows an exemplary microgrid 10, which comprises a plurality of controllable power-generating assets 11, 12, 13, 14. The microgrid 10 may further comprise one or several loads 18, which may comprise one or several controllable loads 15, 16, 17. The one or several controllable loads 15, 16, 17 may comprise one or several discretionary loads. Power generation in the microgrid 10 is controlled by control systems, which include a power management system (PMS) 40 and/or an energy management system (EMS) 50.

The microgrid 10 may be connected to a macrogrid (which is also referred to as main grid). The microgrid 10 may comprise circuit breakers or other disconnectors for controllably connecting and disconnecting the microgrid from the macrogrid.

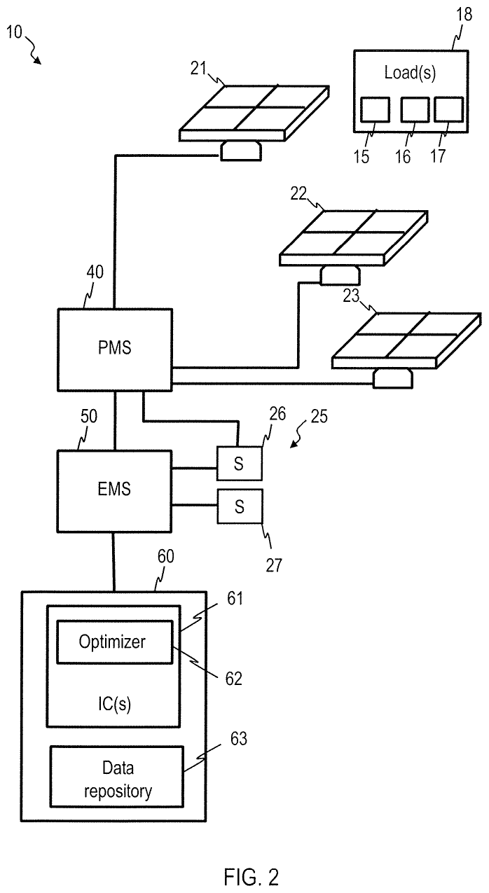

The plurality of controllable power-generating assets 11, 12, 13, 14 may comprise renewable energy sources, such as wind turbines as shown in FIG. 1 or photovoltaic modules 21, 22, 23 as shown in FIG. 2. The plurality of controllable power-generating assets may comprise gas turbines or other generators that operate based on fossil fuels, or energy storage systems (ESS).

The plurality of controllable loads 15, 16, 17 may comprise discretionary loads.

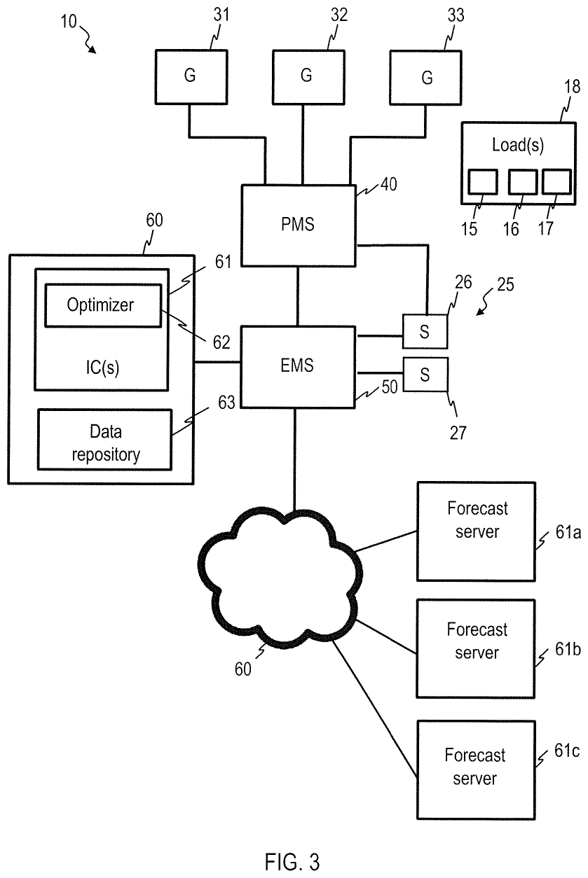

The plurality of controllable power-generating assets 31, 32, 33 are generally illustrated as blocks in FIG. 3, it being understood that the controllable power-generating assets may include wind turbines, photovoltaic modules, other renewable energy sources (RES), generators that consume fossil fuels, or ESS.

The PMS 40 may control and coordinate the individual assets, in particular the controllable power-generating assets and/or controllable loads. The PMS 40 may be operative to use locally known parameters, such as total load, microgrid configuration, storage state of charge (SoC), current PV and wind availability, or other penalization factors etc. for control purposes. The PMS 40 may also include an optimization engine that optimizes operation based on the data available to the PMS 40. This optimization may be limited, as the PMS 40 typically only has access to the locally available values and past and present-time data.

The EMS 50 may include an optimization system that uses forecasts in addition to past and present local data to calculate a better optimal operating point for each of the assets. Forecasts can be for load profiles, PV and wind availability, weather and cloud forecasting, other penalization factors etc.

The EMS 50 may use measured parameters when performing the MOO to determine operating points. The measured parameters may include measurements of one or several of: parameters relating to electric characteristics of at least one asset of the microgrid and/or parameters relating to fluid characteristics (such as transformer insulation fluid, ambient air temperature, ambient air humidity, ambient wind speed, etc.) and/or other parameters (such as averaged solar irradiance).

The PMS 40 may use measured parameters when performing corrective and/or preventive control operations in the microgrid. The measured parameters may include measurements of one or several of: parameters relating to electric characteristics of at least one asset of the microgrid and/or parameters relating to fluid characteristics (such as transformer insulation fluid, ambient air temperature, ambient air humidity, ambient wind speed, etc.) and/or other parameters (such as averaged solar irradiance).

The PMS 40 and/or EMS 50 may be communicatively coupled to a plurality of sensors 26, 27, collectively referred to as sensors 25, that measure parameters and provide the measurements to the PMS 40 and/or EMS 50. The plurality of sensors 25 may be operative to measure parameters related to assets of the microgrid, components connected to the assets, and/or ambient parameters. The plurality of sensors 25 may be operative to measure one or several of: parameters relating to electric characteristics of at least one asset of the microgrid and/or parameters relating to fluid characteristics (such as transformer insulation fluid, ambient air temperature, ambient air humidity, ambient wind speed, etc.) and/or other parameters (such as averaged solar irradiance).

The EMS 50 may be connected via a wide area network 60 to forecast servers 61a, 61b, 61c. The forecast servers may comprise weather forecast servers, energy availability forecast servers, load profile forecast servers, or other forecast servers.

The EMS 50 may execute an optimization procedure to determine optimal operating points for a plurality of controllable assets, in particular controllable power-generating assets and/or controllable loads of the microgrid 10. The EMS 50 may perform a MOO. The MOO may include determining operating points, as a function of time over a predictive horizon (e.g., 24 hours), which cause a composite objective function

$$J ( {OP}_{j} ( t ) ) = {\sum }_{i = 1}^{N} {w}_{i} \times {J}_{i} ( {OP}_{j} ( t ) ) \qquad ( 1 )$$

to be minimum. In Equation (1), OP; designates the operating points for controllable assets j, where the index j is an identifier for the respective asset. Objective functions Jⱼ may include various objectives. The several objective functions Jⱼ may include a first objective function associated with energy transfer to and/or from the main grid (such as a penalty imposed when energy is supplied from the main grid to the microgrid). The several objective functions Jᵢ may include a second objective function associated with power generation in the microgrid (such as a penalty imposed when fossil fuel must be used in the microgrid for power generation; this penalty may include a penalty for carbon dioxide emission). The several objective functions Jᵢ may include a third objective function associated with wear of the ESS (such as a penalty imposed for charging and discharging processes of a BESS, which causes wear). In Equation (1), the weights wᵢ represent weights by which the objective functions are multiplied to determine the composite objective function J.

The objective functions Jⱼ may be dependent not only on operating points, but also on measured parameters and/or other parameters that may be obtained via a user interface, for example. The optimization is then performed using the operating points as variables for which the optimization is performed, under the assumption that the optimization is performed for the measured parameters. For illustration, slowly-varying measurements such as operational characteristics (such as wear) of a power transformer and/or point of common coupling may be taken into account in one or several of the objective functions Jⱼ.

With the use of past, present and future (forecasted) data the EMS calculates the best or optimal operating point for each asset that may be in the form of a power setpoint (e.g. for generators, ESSs, etc.) or a power limit (for PV, wind turbines, etc.), or a load power setpoint (e.g., for discretionary loads). This set of operating points is “optimal” in that it results in an improved metric. Example improved metrics are, less fossil fuel usage, lower emission of CO₂, lower maintenance time, lower down-time, without being limited thereto. The composite objective function of Eq. (1) is a weighted sum of metric values indicating such objectives.

A system 60, which may be distinct from or integral with the system on which the EMS 50 is executed, is operative to set the weights w; by which the objective functions are multiplied to determine the composite objective function J. The computing system 60 may comprise or may be communicatively coupled to a database 63 that includes historical data representative of EMS use cases and operating scenarios. The computing system 60 may be operative to determine, for at least one use case that is similar to the use case in which the EMS 50 is deployed, the weights wᵢ by which the objective functions are multiplied to determine the composite objective function J.

This may be done in an automatic manner, based on (i) a Pareto front of optimal solutions obtained for the optimization problem of Eq. (1) for various parameterizations of the weights w; (under the constraint that the sum of all weights w; is equal to 1) and (ii) a utopia point computed by optimizing two, more than two, or all of the objective functions Jⱼ individually.

The term “utopia point” refers to a point in operating point space for which one of the objective functions, when optimized individually from the other objective functions included in the composite objective function, is optimum (e.g., minimum).

Determining the “utopia point” for an objective function may comprise determining operating points, as a function of time over a predictive horizon (e.g., 24 hours), which cause the objective function

$${J}_{i} ( {OP}_{j} ( t ) ) \qquad ( 2 )$$

to be minimum. In Equation (2), OPⱼ designates the operating points for controllable assets j, where the index j is an identifier for the respective asset. Objective functions Jᵢ may include various objectives. The determination of the utopia point may be performed for one, two, three or more of the objective functions Jᵢ included in the composite objective function.

The value of the objective function, when optimized (e.g., minimized) independently of the other objective functions, is also referred to as utopia value. The term utopia value refers to a value of one of the several objective functions as optimized, when the optimization is performed independently of the other objective functions included in the composite objective function. Thus, the utopia value is the optimal value for just one of the objective functions when optimized disregarding the other objective functions included in the composite objective function. When the MOO is performed, the contribution of an objective function to the optimal value of the composite objective function is greater than the utopia value for this objective function, because the MOO considers several competing objectives.

Determining a set of utopia values and/or utopia points may include determining a first utopia value and/or a first utopia point for which an objective function associated with energy transfer to and/or from the main grid (such as a penalty imposed when energy is supplied from the main grid to the microgrid) is minimum. Determining a set of utopia values and/or utopia points may include determining a second utopia value and/or a second utopia point for which an objective function associated with power generation in the microgrid (such as a penalty imposed when fossil fuel must be used in the microgrid for power generation; this penalty may include a penalty for carbon dioxide emission) is minimum. Determining a set of utopia values and/or utopia points may include determining a third utopia value and/or a third utopia point for which an objective function associated with wear of the ESS (such as a penalty imposed for charging and discharging processes of a BESS, which causes wear) is minimum.

The system 60 includes one or several integrated circuits 61. The integrated circuits 61 may be implemented as processors, microprocessors, controllers, microcontrollers, application specific integrated circuits (ASICs), field-programmable gate arrays (FPGAs) or combinations thereof.

The one or several integrated circuits 61 may be configured, using suitable hardware, firmware, software, to execute an optimizer 62. The system 60 may be configured such that the optimizer 62 is executed
(i) several times to determine the utopia point computed by optimizing two, more than two, or all of the objective functions J; individually; and
(ii) several times to determine the Pareto front of optimal solutions obtained for the optimization problem of Eq. (1) for various parameterizations of the weights w; (under the constraint that the sum of all weights w; is equal to 1).

The optimizations may respectively identify the operating points for which the individual objective function (for utopia point determination) or the composite objective function (for Pareto front generation) become optimal (typically minimum). The optimizations may respectively identify these minimum values of the objective function (for utopia point determination) or the composite objective function (for Pareto front generation), and the parameterizations of the weights w; for various points on the Pareto front.

The optimizations may be performed under constraints. The constraints may comprise one or more of power balance, consistency of a load profile and/or power generation of the microgrid with a predetermined scenario. The constraints may comprise technical constraints of microgrid assets. The constraints may comprise microgrid operator preferences, which may be input via a user interface.

As will be explained in more detail below, the IC(s) 61 may be operative to automatically determine the weights w; by which the objective functions Jᵢ are to be weighted in the composite objective function that is to be used by the EMS 50 in the MOO, by determining a set of utopia values, each of the utopia values corresponding to an optimal value of one of the several objective functions when optimized independently of the other objective functions; determining a Pareto front of optimal solutions, each of the optimal solutions optimizing a different weighted sum of the several objective functions; and determining the weights w; by which the objective functions Jᵢ are to be weighted based on the Pareto front and the set of utopia values.

A distance-based technique may be employed to identify the point on the Pareto front that is closest to the utopia value.

The weights wᵢ may be provided to the EMS 50 for use in performing the MOO. The EMS 50 may perform the MOO such that a composite objective function according to Eq. (1) is minimized, with the weights wᵢ being determined by the system 60. The optimization performed by the EMS 50 may be dependent on measurements captured by the plurality of sensors 25.

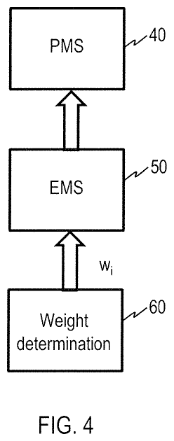

FIG. 4 shows a schematic block diagram, illustrating operation of the microgrid control system.

The system 60 determines the weights w; to be used by the EMS 50 in the MOO. This is done automatically, based on a use case in which the EMS 50 is deployed.

The system 60 provides the weights w; to the EMS 50. The weights may be transferred via a wired or wireless interface. The weights w; may be adjusted during commissioning of the microgrid. The weights wᵢ may be adjusted during field operation of the EMS 50 of the microgrid.

The EMS 50 receives the weights w; and performs the MOO for a composite objective function in which several objective functions are weighted by the provided weights wᵢ. The result of the MOO comprises asset operating points. The EMS 50 provides the asset operating points to the PMS 40. This may be done in a look-ahead manner, e.g., over a predictive time horizon that comprises 6 hours or more, 12 hours or more, 24 hours or more, 48 hours or more.

The predictive time horizon has a certain granularity, with the predictive time horizon comprising an integer number of shorter time intervals. The shorter time intervals may be repetition intervals for data sampling (e.g., from measurement devices) and/or repetition intervals for computations performed by the EMS 50 or PMS 40.

The PMS 40 controls the assets of the microgrid in accordance with the received operating points.

The system 60, the EMS 50, and/or the PMS 40 may be implemented on the same hardware system.

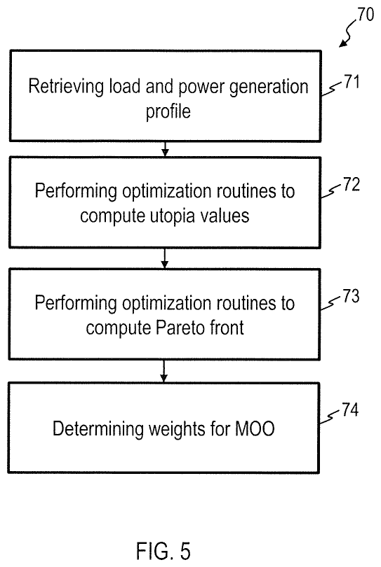

FIG. 5 is a flow chart of a method 70. The method 70 may be performed automatically by the system 60.

At step 71, load and power generation profiles may be retrieved from a database. The database may include historical and/or synthetic profiles. The retrieved load and power generation profiles may be dependent on the microgrid specifications, i.e., the use case in which the EMS 50 is deployed.

At step 72, several optimizations under constraints are performed to determine the utopia values that correspond to the minimum of an objective functions J; when optimized individually. The utopia values may but do not need to be determined for each of the objective functions Jᵢ. For illustration, it may be known that the optimal values for objective functions associated with local power generation in the microgrid may be zero (corresponding to a case in which no fossil fuels are consumed locally in the microgrid), etc. In such cases, the optimization routines for determining the utopia values may be limited to those objective functions that are known to have non-zero minimum values (such as penalties for energy transfer from the main grid to the microgrid).

At step 73, a Pareto front of optimal solutions is computed. This may comprise determining the value of the composite objective function according to Eq. (1), respectively for different parameterizations of the weights wᵢ. The computation of the Pareto front may be performed for various combinations of the weights w selected on a grid, for example. The computation of the Pareto front may be performed for at least two independently variable weights w₁ and w₂, which may be the multiplicative weighting factors applied to the objective function associated with energy transfer to/from the main grid and local power generation in the microgrid, respectively. A third weight w₃ associated with ESS wear may then be w₃=1−w₁−w₂, due to the fact that the sum of the weights is constrained to be equal to 1.

At step 74, the weights to be used in the MOO performed by the EMS 50 are selected based on both the Pareto front and the utopia values. Determining the weights based on the Pareto front and the set of utopia values may comprise determining distances of the utopia point from points on the Pareto front. Determining the weights based on the Pareto front and the set of utopia values may comprise determining a point on the Pareto front that has a minimum distance from the utopia point. The weights by which the objective functions are weighted in the composite objective function may be determined based on weights applied to the several objective functions when determining the point on the Pareto front that has the minimum distance from the utopia point.

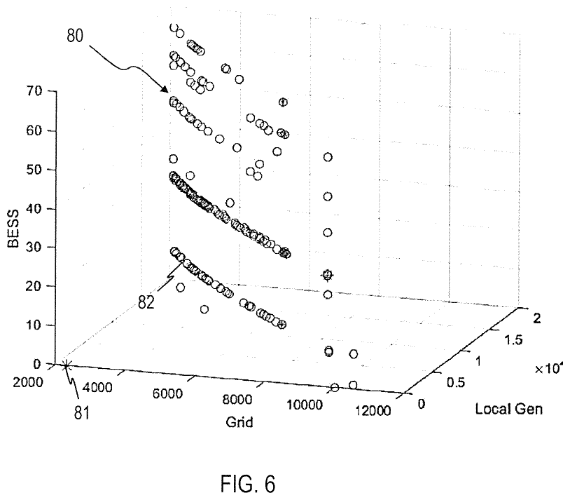

FIG. 6 shows a Pareto front 80 and a utopia point 81. The utopia point 81 may have coordinates in the space spanned by the values for the various individual objective functions J; that are determined by the utopia values. For illustration, one of the coordinates of the utopia point 81 may be a first utopia value that represents a minimum of a first objective function associated with energy production at a grid to which the microgrid is connected, when the first objective function is minimized independently of the other objective functions (but under constraints such as power balance and other technical constraints). Another one of the coordinates of the utopia point 81 may be a second utopia value that represents a minimum of a second objective function associated with local energy production at the microgrid, when the second objective function is minimized independently of the other objective functions (but under constraints such as power balance and other technical constraints). Yet another one of the coordinates of the utopia point 81 may be a third utopia value that represents a minimum of a third objective function associated with ESS wear, when the third objective function is minimized independently of the other objective functions (but under constraints such as power balance and other technical constraints). The second utopia value associated with local energy production may include emission effects, e.g. a penalty imposed for fossil fuel consumption, which is getting increasingly undesirable.

A point 82 on the Pareto front 80 is determined based on both the Pareto front 80 and the utopia point 81. For illustration, the point 82 may be determined to be the point on the Pareto front 80 that has minimum distance (calculated in accordance with a suitable distance metric, such as L₁, L₂, etc.) from the utopia point.

The weights wᵢ for which the point 82 on the Pareto front closest to the utopia point is determined may be identified as the weights that are to be used by the EMS 50 in the MOO.

Other techniques may be used to determine the weights w; that are to be used by the EMS 50 in the MOO. For illustration, balanced or regularized selections may be made.

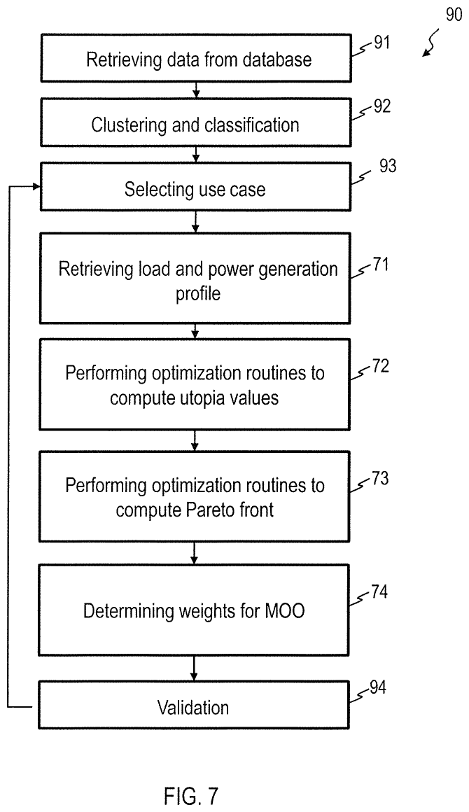

The use cases and/or scenarios used by the system 60 for determining the weights to be used by the EMS 50 in the MOO may be generated from historical and/or synthetic data in a systematic manner. FIG. 7 is an exemplary flow chart of a technique in which clustering and classification are applied.

FIG. 7 is a flow chart of a method 90. The method 90 may be performed automatically by the system 60.

At step 91, data are retrieved from the database 62. The data may comprise historical use cases and/or operating scenarios. The data may comprise synthetic use cases and/or operating scenarios. For illustration, machine learning (ML) techniques may be employed to generate synthetic load and/or power generation profiles of microgrids. The ML model used to generate the synthetic load and/or power generation profiles may have an input layer that receives historical operating scenarios. The ML model may have one or several hidden layers. The ML model may have an output layer that outputs synthetic load and/or power generation profiles.

At step 92, clustering and classification may be performed to identify similar use cases and/or load and power generation profiles. The clustering may comprise a k-means clustering or other clustering techniques.

At step 93, a use case is selected. If it is already known for which EMS 50 the weights are to be determined, the use case may be selected based on the intended deployment scenario of the EMS 50. For illustration, a use case may be selected that has a same or similar type of renewable energy resource as the microgrid in which the EMS 50 is deployed or that has similar average power generation and/or load values.

At steps 71-74, the weights are determined. This may be done as described with reference to FIG. 5. The specific use case selected determines the load and/or power generation profiles and constraints that are imposed when determining the utopia values and the Pareto front.

At step 94, a validation may be performed. The validation may comprise a simulation in which the MOO when performed using the determined weights is checked against historical data that are known to represent valid control strategies, for example.

Steps 93, 71-74, and 94 may be repeated. For illustration, if several similar use cases are available, the weights may be determined for the several use cases. The set of weights that is assessed to outperform the others in the validation at step 94 may be deployed to the EMS 50. Alternatively or additionally, sets of weights may be generated pro-actively for various use cases and may be stored for deployment to the EMS 50, either during commissioning or during field use.

Various effects are associated with the methods and systems according to embodiments. For illustration, the methods and systems allow parameters of a MOO performed by an EMS to be adjusted. This may be done automatically and based on objective criteria. Commissioning and/or reconfiguration of an EMS is facilitated.

While the invention has been described in detail in the drawings and foregoing description, such description is to be considered illustrative or exemplary and not restrictive. Variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A method of operating an energy management system (EMS) for a microgrid,
wherein the EMS performs a multi-objective optimization (MOO) to determine one or several asset operating points over a predictive time horizon, wherein performing the MOO determines the one or several asset operating points as a function of time over the predictive time horizon that minimize a composite objective function that is a weighted sum of several objective functions,
wherein the method comprises automatically determining, by at least one integrated circuit, weights by which the several objective functions are weighted in the composite objective function that is to be used by the EMS in the MOO.

2. The method of claim 1, wherein automatically determining the weights by which the objective functions are to be weighted in the composite objective function that is to be used by the EMS in the MOO comprises the following steps performed using the at least one integrated circuit:
determining a set of utopia values, each of the utopia values corresponding to an optimal value of one of the several objective functions when optimized independently of the other objective functions;
determining a Pareto front of optimal solutions, each of the optimal solutions optimizing a different weighted sum of the several objective functions; and
determining the weights by which the objective functions are to be weighted based on the Pareto front and the set of utopia values.

3. The method of claim 2, wherein determining the weights based on the Pareto front and the set of utopia values comprises determining a utopia point having coordinates defined by the set of utopia values.

4. The method of claim 3, wherein determining the weights based on the Pareto front and the set of utopia values comprises determining distances of the utopia point from points on the Pareto front.

5. The method of claim 3, wherein determining the weights based on the Pareto front and the set of utopia values comprises determining a point on the Pareto front that has a minimum distance from the utopia point.

6. The method of claim 5, wherein the weights by which the objective functions are weighted in the composite objective function are determined based on weights applied to the several objective functions when determining the point on the Pareto front that has the minimum distance from the utopia point.

7. The method of claim 2, wherein determining the utopia values comprises determining a first utopia value that represents a minimum of a first objective function associated with energy production at a grid to which the microgrid is connected and determining a second utopia value associated with local energy production at the microgrid.

8. The method of claim 2, wherein determining the weights comprises determining a first weight by which a first objective function associated with energy production at a grid to which the microgrid is connected is multiplied in the composite objective function, and a second weight by which a second objective function associated with local energy production at the microgrid is multiplied in the composite objective function.

9. The method of claim 2, wherein
determining the utopia values and determining the Pareto front respectively comprises performing an optimization under constraints.

10. The method of claim 2, wherein the steps of determining the utopia values, determining the Pareto front, and determining the weights are respectively performed for each one of a plurality of different scenarios.

11. The method of claim 1, further comprising:
clustering data obtained for a plurality of microgrids to identify a plurality of use cases;
wherein automatically determining the weights is performed for at least one of the use cases.

12. The method of claim 1, further comprising:
performing, by the EMS, the MOO to determine the one or several asset operating points as a function of time over the predictive time horizon, wherein the objective function in the MOO depends on the determined weights.

13. The method of claim 1, further comprising:
providing, by the EMS, the one or several asset operating points to a power management system (PMS); and
controlling, by the PMS, controllable assets of the microgrid in accordance with the operating points determined by the EMS.

14. A system for controlling operation of an energy management system (EMS), wherein the EMS is operative to perform a multi-objective optimization (MOO) to determine one or several asset operating points over a predictive time horizon, wherein the MOO determines the one or several asset operating points as a function of time over the predictive time horizon that minimize a composite objective function that is a weighted sum of several objective functions, the system comprising:
at least one integrated circuit operative to automatically determine weights by which the objective functions are weighted in the composite objective function that is to be used by the EMS in the MOO; and
an interface to provide the determined weights to the EMS.

15. A microgrid, comprising:
a plurality of controllable assets;
an energy management system (EMS), wherein the EMS is operative to perform a multi-objective optimization (MOO) to determine one or several asset operating points over a predictive time horizon, wherein the MOO determines the one or several asset operating points as a function of time over the predictive time horizon that minimize a composite objective function that is a weighted sum of several objective functions; and
the system of claim 14.

16. The method of claim 7, wherein the second utopia value associated with local energy production includes emission effects.

17. The method of claim 8, wherein determining the weights further comprises determining a third weight by which a third objective function associated with an energy storage system of the microgrid is multiplied, and wherein the second objective function includes emission effects.

18. The method of claim 9, wherein the constraints comprise one or more of power balance, consistency of a load profile, and/or power generation of the microgrid with a predetermined scenario.

19. The method of claim 10, wherein the different scenarios are distinguished from each other with respect to load and/or power generation profiles of the microgrid.

20. The method of claim 12, wherein the predictive time horizon comprises at least 24 hours.
